(19) United States
(12) Patent Application Publication
(10) Pub. No.: US 2025/0351804 A1
(43) Pub. Date: Nov. 20, 2025

(54) APPARATUS FOR FEEDING BEES

(71) Applicant: Technically Beekeeping LLC, Gurnee, IL (US)

(72) Inventors: Michael J. Erpenbeck, Gurnee, IL (US); Michael Francis Gilligan, Milwaukee, WI (US); David B. Atkinson, Kingsland, GA (US); Jennifer L. Erpenbeck, Gurnee, IL (US); Anna C. Erpenbeck, Gurnee, IL (US)

(21) Appl. No.: 18/665,101

(22) Filed: May 15, 2024

(51) Int. Cl. A01K 53/00

(52) U.S. Cl. CPC A01K 53/00

(57) ABSTRACT

Systems, apparatus, articles of manufacture, and methods are disclosed for liquid bee feeders. An example liquid bee feed includes a vessel to contain liquid bee feed. A lid is removably coupled to the vessel. The lid includes a recess having a sidewall extending into the vessel and a fluid channel through sidewall to fluidly couple the vessel and the recess. A plug is movably coupled to the lid and disposed within the recess to impede the liquid bee feed from flowing through the fluid channel while in a first position. The plug includes a first surface including a feeding port, a second surface extending from the first surface towards the recess, and an opening on the second surface. The opening aligns with the fluid channel when the plug is in a second position to allow the liquid bee feed to flow through the fluid channel and through the feeding port.

### FIELD OF THE DISCLOSURE

This disclosure relates generally to bee hives and, more particularly, to apparatus for feeding bees.

### BACKGROUND

In recent years, hobby beekeeping has grown more popular. Backyard apiaries, hives, and other amateur beekeeping structures have different requirements than larger, more industrial apicultural operations. Beekeepers utilize a mixture of commercially available, repurposed, or self-made equipment for routine care and maintenance of hives. One key aspect of beekeeping is feeding the bees within a hive, particularly in climates where environmental nectar is not available year-round. Bee feed can be solid or liquid. The solid bee feed is often used in late fall when temperatures drop, and the bees would otherwise feed on honey stores. Liquid bee feed is often used in warmer times of dearth, such as early spring or autumn. Liquid feed must be presented to the bees in a way that minimizes the risk of the bees drowning. Liquid feed is often presented so that it can be accessed directly from the hive.

### BRIEF DESCRIPTION OF THE DRAWINGS

FIG. 1 shows an example hive where an example liquid bee feeder can be used.

FIG. 2 is an exploded view of the example liquid bee feeder of FIG. 1 showing an example vessel, an example lid, and an example band.

FIGS. 3A-3D show the liquid bee feeder of FIG. 2 with an example plug in a closed position and an open position.

FIG. 4 is a cross-sectional view of the liquid bee feeder of FIG. 2 showing how example liquid bee feed dispenses from the liquid bee feeder when the plug is in the open position.

FIGS. 5A-5C show the lid of the liquid bee feeder of FIG. 2 at side and perspective angles to illustrate example fluid channels of the lid.

FIGS. 5D-5F show the plug of the liquid bee feeder of FIG. 2 at side and perspective angles to illustrate example passages and openings of the plug.

FIGS. 6A and 6B illustrate another example liquid bee feeder that includes a sliding seal cover.

FIGS. 7A and 7B illustrate example ultraviolet lights that can be used with the example liquid bee feeder of FIG. 2.

FIGS. 8A-8D show another example liquid bee feeder with an example plug in an example closed position and an example open position.

In general, the same reference numbers will be used throughout the drawing(s) and accompanying written description to refer to the same or like parts. The figures are not necessarily to scale.

### DETAILED DESCRIPTION

Many known liquid bee feeders for amateur beekeepers are repurposed household items. However, this requires modifying the household item to make the item usable for distributing liquid bee feed. Improperly modified items can be dangerous to bees. Holes added to fluid vessels can have irregular shapes or incorrect sizes that can cause undesirable flow characteristics of the liquid bee food or cause structural instability to the vessel. This can result in too much or too little liquid feed coming out of the repurposed liquid bee feeder. In some cases, the added holes can have sharp edges that can damage the bees as they attempt to feed.

Example liquid bee feeders described herein bridge the gap between repurposed liquid bee feeders and commercial scale bee feeders. By utilizing common glass jars (e.g., mason jars) as fluid vessels to contain the liquid bee feed, hobby beekeepers can easily acquire, clean, and maintain multiple vessels for liquid bee feed. Different size vessels can be utilized with the liquid bee feeder to fit within the hive or hive structure (e.g., a cover, a super, a medium honey super, etc.) or to supply different amounts of liquid bee feed.

Example liquid bee feeders described herein include sealed lids to prevent accidental spilling of the liquid bee feed. The liquid bee feeders can be oriented for placement on a hive inner cover and then opened without spillage. Once placed on the inner cover, the example liquid bee feeder allows bees to drink the liquid bee feed safely.

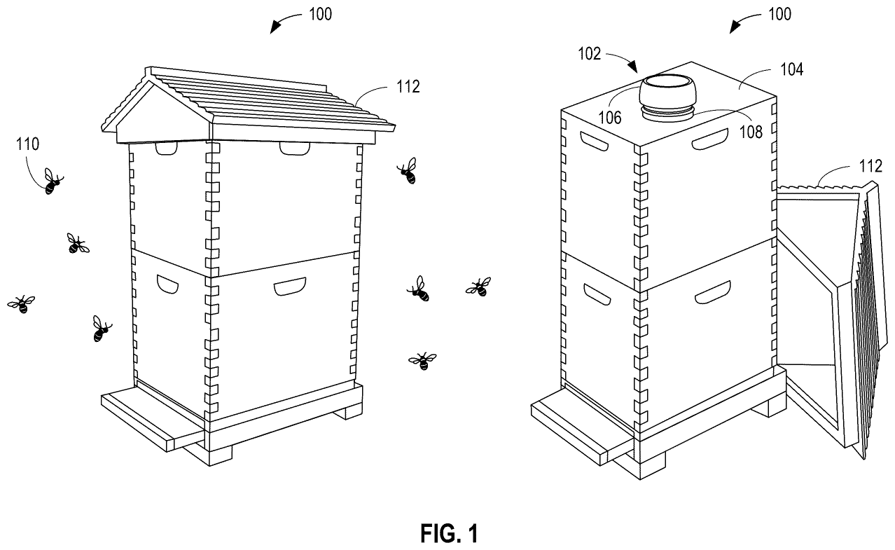

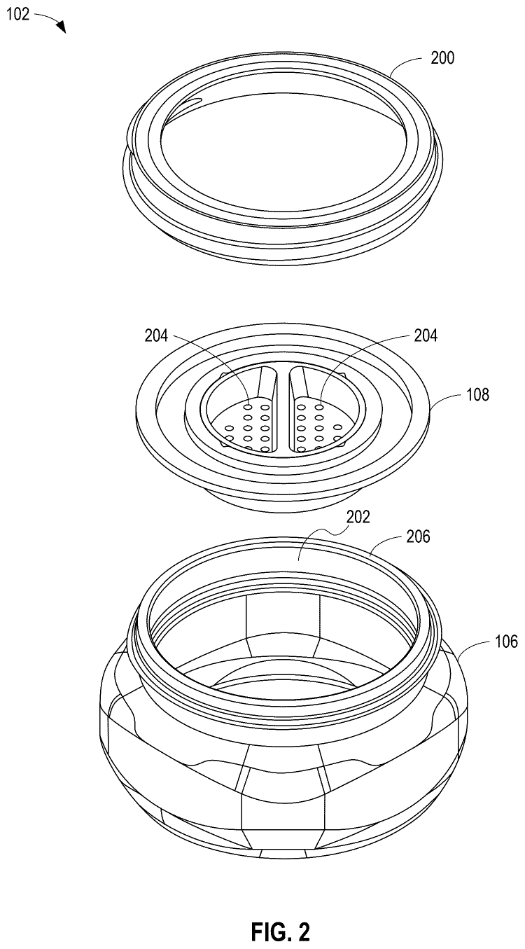

FIG. 1 shows an example hive 100 where an example liquid bee feeder 102 can be used. In this example, the liquid bee feeder 102 is placed on an example inner cover 104 of the hive 100 with an example vessel 106 of the liquid bee feeder above a corresponding example lid 108 (further detailed below in reference to FIG. 2). In this way, bees 110 can access the liquid bee feeder 102 from below the inner cover 104 through an example opening (not shown). In some examples, the liquid bee feeder 102 is placed on the inner cover 104 of the hive 100 and an example outer cover 112 (e.g., roof, telescoping cover, gabled roof cover, etc.) is placed over the inner cover 104 and the liquid bee feeder 102. In other examples, the liquid bee feeder 102 is placed near or mounted on the hive 100 such that the bees 110 leave the hive to access the liquid bee feed.

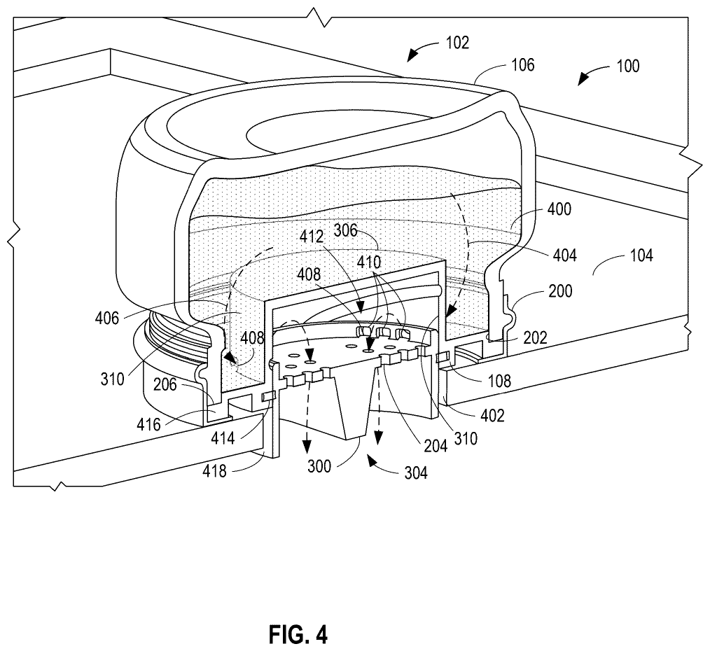

FIG. 2 is an exploded view of the example liquid bee feeder 102 of FIG. 1 showing the vessel 106, the lid 108, and an example band 200. FIG. 2 shows the vessel 106 as a glass jar (e.g., mason jar). Some example vessels are glass jars of different sizes or shapes. In other examples, the vessel 106 is a different material (e.g., plastic, metal). In some examples the vessel 106 has a size and shape different than a jar to best fit inside a hive (e.g., the hive 100). The lid 108 fits within an example opening 202 (e.g., mouth) of the vessel 106. In this way, the lid 108 forms a seal (e.g., to at least partially seal) on the vessel 106 so that liquid bee feed can be stored within the vessel 106 in any orientation. The lid 108 has example passages 204 (e.g., openings, feeding ports) that allow liquid bee feed to be accessed by bees for feeding, discussed in more detail below in reference to FIG. 4. For clarity, not every passage 204 is labeled in FIG. 2, but it is understood that similar shapes in proximity to a labeled passage 204 is also a passage 204. The band 200 is shown in FIG. 2 as a metal ring that threadably engages with the vessel 106 to hold the lid 108 sealed against an example rim 206 of the vessel 106. In some examples, the band 200 can be made of different materials (e.g., plastic). In other examples, the lid 108 is removably held to the vessel 106 using different fixtures (e.g., clamps, latches, buckles, straps, etc.). In some examples the band 200 is fixed to the lid 108 or the band 200 is an exterior feature of the lid 108. The example liquid bee feeder 102 of FIG. 2 allows users to source widely available known jars and bands (e.g., mason jars, Ball® jars, Kerr® jars, etc.) to assemble to the lid 108. This provides flexibility as components can be easily replaced if damaged or resized to suit different bee feeding needs.

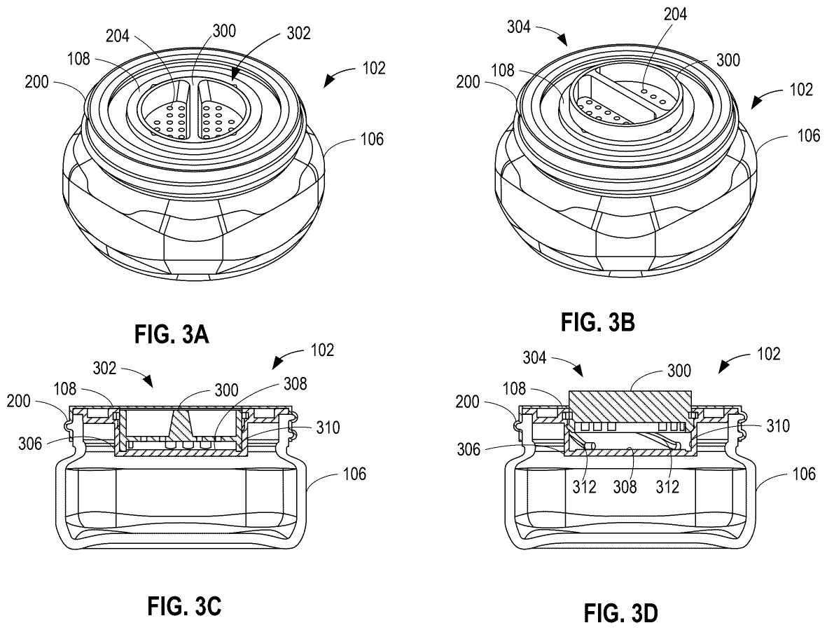

FIGS. 3A-3D show the liquid bee feeder 102 of FIG. 2 with an example plug 300 in a closed position 302 and an open position 304. The plug 300 is movable between the closed position 302 and the open position 304. The plug 300 is disposed within an example recess 306 of the lid 108, as shown in FIGS. 3C-3D. The plug 300 contacts an example bottom surface 308 and an example sidewall 310 of the recess 306 when the plug 300 is in the closed position 302. In this way, the plug 300 seals or otherwise impedes fluid flow through fluid channels (not shown) in the lid 108. FIGS. 3A and 3C illustrate that the plug 300 sits flush with (e.g., does not protrude past) the lid 108 when in the closed position 302. In this way, the liquid bee feeder 102 can be stacked with other liquid bee feeders 102 for storage and/or transport. FIGS. 3B and 3D illustrate the plug 300 in the open position 304. The plug 300 moves away from the bottom surface 308 of the recess 306 to reach the open position 304. Thus, the plug 300 extends past the lid 108 when the plug 300 is in the open position 304. As discussed in further detail below in relation to FIG. 4, the plug 300 no longer inhibits fluid flow through the fluid channels (not shown) in the lid 108 while the plug 300 is in the open position 304. FIG. 3D shows grooves 312 in the sidewall 310 of the recess 306. The grooves 312 guide the plug 300 as it moves from the open position to the closed position. In some examples, the grooves 312 are helical to cause the plug 300 to move away from the bottom surface 308 of the recess 306 as the plug 300 is rotated between the closed position 302 and the open position 304. In other examples, the grooves 312 guide the motion of the plug 300 in a different way (e.g., locking the plug 300 in the closed position 302, locking the plug 300 in the open position 304, guiding the plug 300 without rotation, etc.).

FIG. 4 is a cross-sectional view of the liquid bee feeder 102 of FIG. 2 showing how example liquid bee feed 400 dispenses from the liquid bee feeder 102 when the plug 300 is in the open position 304. The liquid bee feed 400 is stored in the vessel 106 with the plug 300 in the closed position 302 (not shown). When the liquid bee feeder 102 is to be deployed, the liquid bee feeder 102 is inverted such that the lid 108 is below the vessel 106. Once the liquid bee feeder 102 is inverted, the plug 300 is moved from the closed position 302 to the open position 304. In this way, the liquid bee feed 400 moves toward the lid 108 before the plug 300 is moved to the open position 304. When the liquid bee feed 400 flows to exit the lid 108, the liquid bee feed 400 creates a low pressure within the vessel 106 which, combined with the high viscosity of the liquid bee feed 400, reduces or eliminates unwanted leakage of the liquid bee feed 400. In other words, the liquid bee feeder 102 prevents leaks (e.g., spillage) of liquid bee feed 400 when deploying the liquid bee feeder 102 by sealing the liquid bee feeder 102 with the plug 300 until the liquid bee feeder 102 is fully inverted (e.g., the lid 108 is below the vessel 106 and approximately parallel with the ground). The passages 204 (only one of which is labeled for clarity) are sized to prevent the liquid bee feed 400 (e.g., a high viscosity syrup) from free flowing while allowing bees to ingest the liquid bee feed 400. In some examples, the passages 204 are sized between approximately 0.5 and 4 millimeters in diameter (e.g., 0.5 millimeters, 1 millimeter, 1.2 millimeters, 2 millimeters, 3 millimeters, etc.).

FIG. 4 shows the liquid bee feeder 102 placed on the inner cover 104 of the hive 100 of FIG. 1. The inner cover 104 has an example opening 402 through which bees can access the liquid bee feeder 102 from within the hive 100. The plug 300 has a diameter that is smaller than the opening 402 such that the plug 300 nests inside the opening 402 when the plug 300 is in the open position 304. In this way, the plug 300 can be used to position the liquid bee feeder 102 on the inner cover 104 by inserting the plug 300 into the opening 402. Once positioned, the liquid bee feeder 102 prevents bees from moving past the inner cover 104 of the hive 100 through the opening 402.

FIG. 4 shows two example flow paths 404, 406 that the liquid bee feed 400 can take to the passages 204 (e.g., openings, feeding ports, holes, etc.). The flow paths 404, 406 start inside the vessel 106 and proceed through example fluid channels 408 (e.g., openings) on the sidewall 310 of the recess 306, through example openings 410 of the plug 300, into an example feed cavity 412, and finally to the passages 204 (e.g., openings, feeding ports). In other words, the vessel 106, the fluid channels 408, the openings 410, the feed cavity 412, and the passages 204 are fluidly coupled. For clarity, not all passages 204 are labeled. The fluid channels 408 are shown with example positions and distributed across the sidewall 310 of the recess 306. In other examples, a different number and/or location of fluid channels 408 are present on the lid 108 which are blocked when the plug 300 (e.g., a cover) is in the closed position 302. The fluid channels 408 and the openings 410 are approximately the same size (e.g., same cross-sectional shape, same cross-sectional area, etc.). In other examples, the openings 410 can have a different size and/or number (e.g., one large opening 410 aligning with multiple fluid channels 408, multiple smaller openings 410 aligning with a single fluid channel 408, etc.). In some examples, the plug 300 includes a single opening 410 that aligns with a single fluid channel 408 on the sidewall 310 when the plug is in the open position 304. The example single opening 410 and the example single fluid channel 408 slow the liquid bee feed 400 as it enters the feed cavity 412. In this way, less liquid bee feed 400 enters the feed cavity 412 when the liquid bee feeder 102 is inverted and placed on the inner cover 104, thus reducing an amount of liquid bee feed 400 that is spilled during placement of the liquid bee feeder 102. An example elastomeric ring 414 (e.g., O-ring, seal, washer, etc.) surrounds the plug 300 to impede fluid flow (e.g., at least partially seal) between the sidewall 310 of the recess 306 and the plug 300. In other examples, the sidewall 310 of the recess 306 and the plug 300 are sized fit together such that fluid flow is impeded between them (e.g., at least partially sealed).

The lid 108 is coupled to vessel 106 with the band 200. The band 200 is threadably coupled to the vessel 106 and applies a pressure between an example flange 416 of the lid 108 and the rim 206 of the vessel 106. The flange 416 is shaped to center the lid 108 within the opening 202 (e.g., the mouth) of the vessel 106. In some examples, the flange 416 is textured (e.g., provided with a surface roughness) or shaped (e.g., serrated, knurled, etc.) to increase friction between the flange 416, the vessel, and/or the band 200. In some examples, the lid 108 has a flat outer edge and is centered on the rim 206 by the band 200. The recess 306 of the lid 108 extends into the vessel 106 and is approximately concentric with the opening 202 of the vessel. In some examples, the plug 300 has an example cylindrical sidewall 418. In some examples, the sidewall 418 has a draft taper (e.g., a conical shape). The plug 300 is concentric with the recess 306 and dimensioned so that the sidewall 418 nests within the sidewall 310. In this way, the plug 300 can rotate and translate within the recess 306.

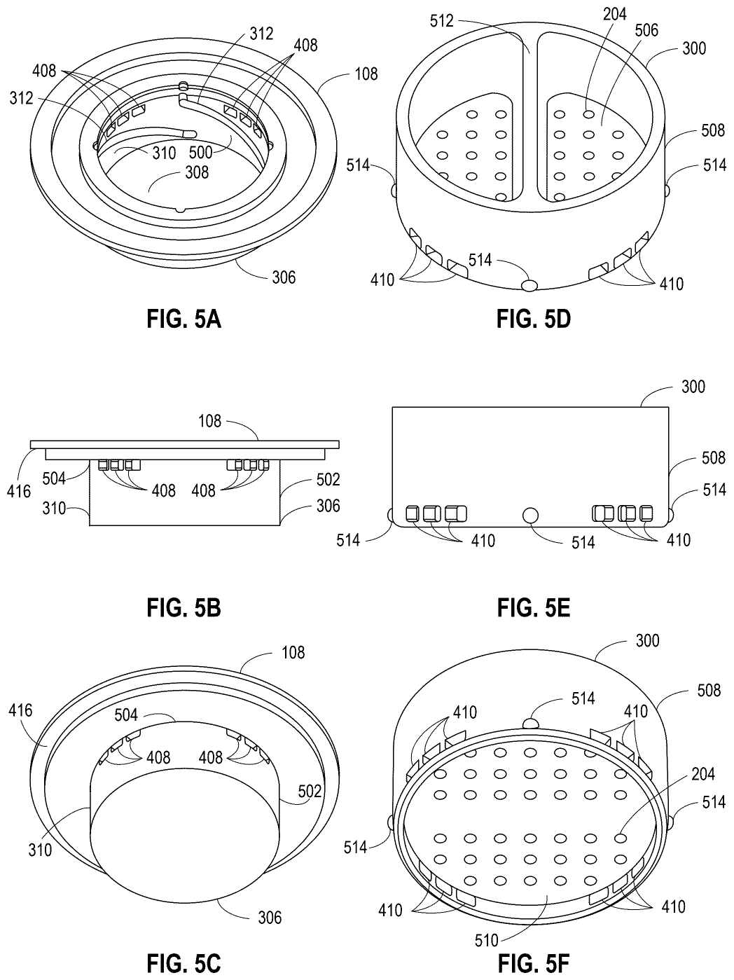

FIGS. 5A-5C show the lid 108 of the liquid bee feeder 102 of FIG. 2 at side and perspective angles to illustrate the example fluid channels 408 of the lid 108. The fluid channels 408 fluidly couple an example first side 500 of the sidewall 310 (as shown in FIG. 5A) with an example second side 502 of the sidewall 310 (as shown in FIGS. 5B and 5C). In this example, twelve fluid channels 408 are arranged on the sidewall 310 of the recess 306 in sets of three fluid channels 408 adjacent to an example top edge 504 of the recess 306 spaced approximately 90 degrees apart around the circumference of the sidewall 310. In some examples, a different number of fluid channels 408 are on the lid 108 (e.g., one fluid channel 408, two fluid channels 408, four fluid channels 408, etc.). In some examples, the fluid channels 408 are located on a different part of the lid 108 (e.g., adjacent to the bottom surface 308 of the recess 306, between the top edge 504 and bottom surface 308 of the recess 306, on the bottom surface 308, etc.).

The recess 306 is shown as a cylindrical depression in the lid 108 in FIGS. 5A-C. In some examples, the recess 306 has a draft taper (e.g., a conical shape) such that a diameter of the recess 306 is larger near the top edge 504 than near the bottom surface 308. The bottom surface 308 of the recess 306 has a flat shape. In other examples, the bottom surface has a different shape (e.g., curved, angled, convex, concave, etc.). The sidewall 310 of the recess 306 has four grooves 312 to guide the motion of the plug 300. In other examples, the sidewall 310 has a different number of grooves 312 (e.g., one groove 312, two grooves 312, etc.). The grooves 312 provide a helical path. In other examples, the grooves 312 can provide a different path (e.g., perpendicular to the bottom surface 308, parallel to the bottom surface 308, compound paths, etc.). The grooves 312 have a semi-circular cross-section. In other examples, the grooves 312 have a different cross-sectional shape (e.g., rectangular, triangular, curved, etc.). In some examples, the grooves 312 are detents used to hold the plug 300 in the open position (e.g., open position 304) and/or closed position (e.g., closed position 302). The lid 108 of FIGS. 5A-5C has a circular shape with a flange 416 around the perimeter to mate with the vessel 106 (not shown). In other examples, the lid 108 has a different shape to match the shape of the vessel 106 (e.g., rectangular shape).

In some examples, the lid 108 and/or the plug 300 is made from a plastic material. In some examples, the lid 108 and/or the plug 300 is made from colored plastic to make it more attractive to bees. In some examples, the lid 108 and/or the plug 300 includes ultraviolet light reflecting materials (e.g., materials that preferentially reflect ultraviolet light while absorbing other light spectra) and/or ultraviolet light absorbing materials to attract bees to feed. In some examples, the lid 108 and/or the plug 300 is made from low surface energy materials (e.g., hydrophobic materials, non-stick materials, Teflon, etc.) to discourage bees from building comb (e.g., depositing wax) on the lid 108 and/or the plug 300.

FIGS. 5D-5F show the plug 300 of the liquid bee feeder 102 of FIG. 2 at perspective and side angles to illustrate the example passages 204 and the example openings 410 of the plug 300. For clarity, not all passages 204 are labeled. The passages 204 are arranged on a top surface 506 on plug 300 to act as feeding ports for bees. In other words, the passages 204 are positioned on the plug 300 so that the openings are approximately perpendicular to the ground when the liquid bee feeder 102 (not shown) is deployed for feeding bees (e.g., the liquid bee feeder 102 is positioned with the vessel 106 above the lid 108 with the plug 300 in the open position 304). The top surface 506 is shown with thirty-eight passages 204 arranged in a grid. In other examples, the top surface 506 has a different number of passages 204 (e.g., more than 38, less than 38). In some examples, the passages 204 are arranged in a different pattern. In some examples, the passages 204 are arranged to be at least 5 millimeters apart (e.g., a center of a first passage 204 is 5 or more millimeters from a center of a next closest (e.g., adjacent) second passage 204) to allow space for bees to feed.

The plug 300 has a cylindrical shape with a sidewall 508. In some examples the plug 300 has a tapered (e.g., conical shape). In some examples, the sidewall 508 extends past the top surface 506 and a bottom surface 510, the top surface 506 and bottom surface 510 fluidly coupled by the passages 204. The openings 410 are positioned on the sidewall 508 to fluidly connect the sidewall 508 with the bottom surface 510. In this example, twelve openings 410 are arranged on the sidewall 508 of the plug 300 in sets of 3 openings 410 adjacent to the bottom surface 510 of the plug 300, spaced approximately 90 degrees apart around the circumference of the sidewall 508. In this way, the openings 410 align with the fluid channels 408 of the lid 108 when the plug is in the open position 304 (as shown in FIG. 4). In some examples, a different number of openings 410 are on the plug 300 (e.g., one opening 410, two openings 410, four openings 410, etc.). The openings 410 are rectangular in shape. In other examples, the openings 410 have a different shape (e.g., circular, polygonal). In some examples, the openings 410 have different sizes (e.g., larger, smaller).

The plug 300 of FIG. 5D includes a raised portion 512 that rises from the top surface 506. The raised portion 512 serves as a grip (e.g., handle) to receive user input to move the plug 300 from the closed position 302 to the open position 304. The raised portion 512 extends across the top surface 506 along a diameter of the sidewall 508 and extends from the top surface 506 to a height equal to the sidewall 508. In other examples the raised portion 512 does not extend all the way to the sidewall 508. In some examples the top surface 506 and/or the raised portion 512 has a textured surface (e.g., surface finish greater than Ra 3.2 μm) to allow bees to comfortably grip the plug 300 while feeding.

The plug 300 of FIGS. 5D-5F includes four protrusions 514 (only three are visible) on the sidewall 508. The protrusions 514 move within the grooves 312 of the lid 108 to guide the plug 300 between the closed position 302 and the open position 304. In some examples, there is a different number of protrusions 514 (e.g., two protrusions 514, three protrusions 514, etc.). The protrusions 514 have a hemispherical shape. In some examples, the protrusions 514 have a different shape (e.g., cube, pyramid, etc.). In some examples, the protrusions 514 are helical threads that mate with helical grooves 312.

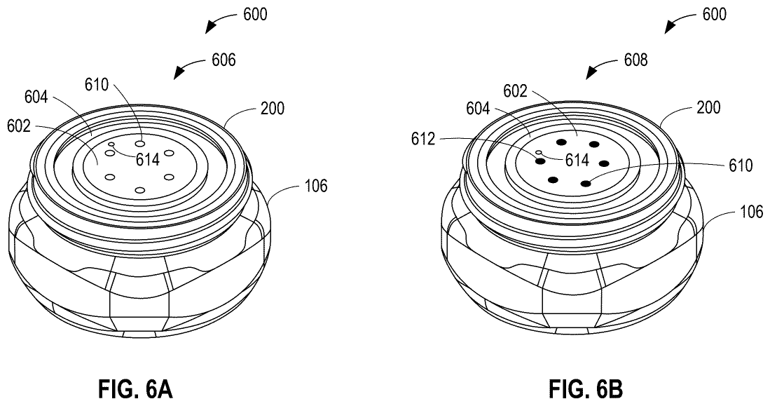

FIGS. 6A and 6B illustrate another example liquid bee feeder 600 that includes an example sliding seal cover 602. The liquid bee feeder 600 includes an example lid 604 coupled to the vessel 106 by the band 200. The cover 602 is movably (e.g., slidably) coupled to the lid 604. The cover 602 moves (e.g., rotates) between an example closed position 606 and an example open position 608. The cover 602 has example openings 610 that align with example fluid channels 612 in the lid 604 when the cover 602 is in the open position 608. In other words, the liquid bee feeder 600 is sealed when the cover 602 is in the closed position 606 and fluid can exit the liquid bee feeder 600 when the cover 602 is in the open position 608. For clarity, not all of the openings 610 and fluid channels 612 are labeled. The cover 602 includes a raised portion 614 that accepts a user input to move the cover between the closed position 606 and the open position 608. In some examples, the raised portion 614 is elongate to center the cover 602 in an inner cover opening (e.g., the inner cover opening 402 of FIG. 4). In other examples, the cover 602 is flat and has no raised portion 614. In some examples, the cover 602 rotates between the closed position 606 and the open position 608. In other examples, the cover 602 slides (e.g., translates) between the closed position 606 and the open position 608. FIGS. 6A and 6B illustrate the cover 602 as having a circular shape. In other examples, the cover 602 can have a different shape (e.g., square, triangular, rhombus, etc.). The cover 602 has six openings 610 equally spaced in a circular pattern. In other examples, the cover 602 can have a different number of openings 610 arranged in a different pattern. In some examples, the fluid channels 612 are the same size and shape as the openings 610. In other examples, the fluid channels 612 can be larger or smaller than the openings 610. In some examples, the fluid channels 612 have different shapes than the openings 610. In some examples, the fluid channels 612 only partially align with the openings 610 when the cover 602 is in the open position 608. In some examples the cover 602 has a textured surface (e.g., surface finish greater than Ra 3.2 μm) to allow bees to comfortably grip the cover 602 while feeding.

In some examples, the lid 604 and/or the cover 602 is made from a plastic material. In some examples, the lid 604 and/or the cover 602 is made from colored plastic to make it more attractive to bees. In some examples, the lid 604 and/or the cover 602 include ultraviolet light reflecting materials (e.g., materials that preferentially reflect ultraviolet light while absorbing other light spectra) and/or ultraviolet light absorbing materials to attract bees to feed. In some examples, the lid 604 and/or the cover 602 is made from low surface energy materials (e.g., hydrophobic materials, non-stick materials, Teflon, etc.) to discourage bees from building comb (e.g., depositing wax) on the lid 604.

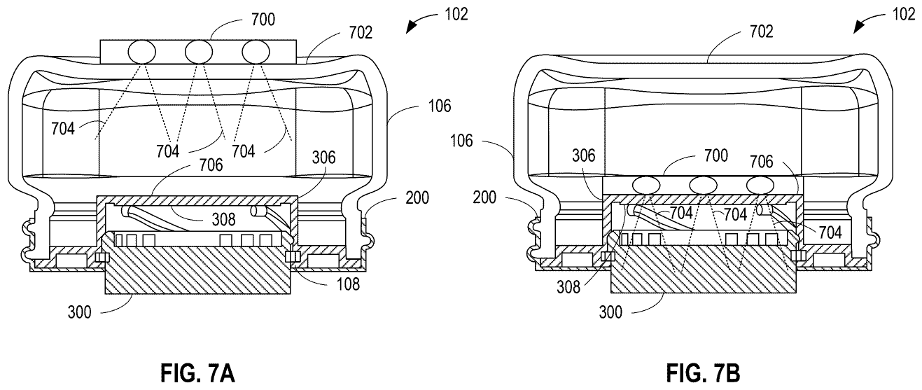

FIGS. 7A and 7B illustrate example ultraviolet lights 700 that can be used with the example liquid bee feeder 102 of FIG. 2. The ultraviolet lights 700 includes an ultraviolet light source (e.g., a light emitting diode, a filament bulb, etc.) and a power source (e.g., battery) (not shown). The ultraviolet lights 700 of FIG. 7A are coupled to a bottom side 702 of the vessel 106 to emit ultraviolet light 704 through the vessel 106, which in this example is clear (e.g., translucent, transparent). The ultraviolet light 704 is directed through the vessel 106 towards the recess 306. In some examples, the recess 306 is clear (e.g., translucent, transparent) to allow ultraviolet light 704 to pass through the recess 306 towards the plug 300. In some examples, the ultraviolet light 704 passes through passages 204 (not shown) in the plug 300 to be seen by bees. In other examples, the plug 300 is clear (e.g., translucent, transparent) allowing the ultraviolet light 704 to pass through the plug 300 to be seen by bees. The ultraviolet light 704 attracts attention of bees to draw them towards the liquid bee feeder 102 to feed. In this way, the bees find the liquid bee feeder 102 without the use of added attractants (e.g., lemongrass oil) in the liquid bee feed. In some examples, the ultraviolet lights 700 are configured to emit ultraviolet light 704 for a predetermined or fixed period of time (e.g., for 1 hour, for 3 hours, continuously, etc.) per day. In this way, the ultraviolet light 704 helps limit growth of mold, bacteria, and/or other spores within the vessel 106 and/or the liquid bee feed 400 (not shown). While in this example the ultraviolet lights 700 are shown with the vessel 106, the ultraviolet lights 700 can be used with any other vessel or container. For example, a beekeeper wishing to limit growth of mold and/or bacteria in liquid bee feed can place a liquid bee feeder (e.g., the liquid bee feeder 102) in the beehive, couple ultraviolet lights (e.g., the ultraviolet lights 700) to a vessel (e.g., the vessel 106) of the liquid bee feeder, and activate the ultraviolet lights such that ultraviolet light enters the vessel to inhibit growth of mold, bacteria, and/or other spores. FIG. 7B shows example ultraviolet lights 700 coupled to an inner surface 706 of the recess 306, opposite the bottom surface 308. As described above, the ultraviolet lights 700 of FIG. 7B emit ultraviolet light 704 through the recess 306 and through the plug 300 and/or the passages 204 to be seen by bees. In some examples, the ultraviolet lights 700 are embedded in the recess 306.

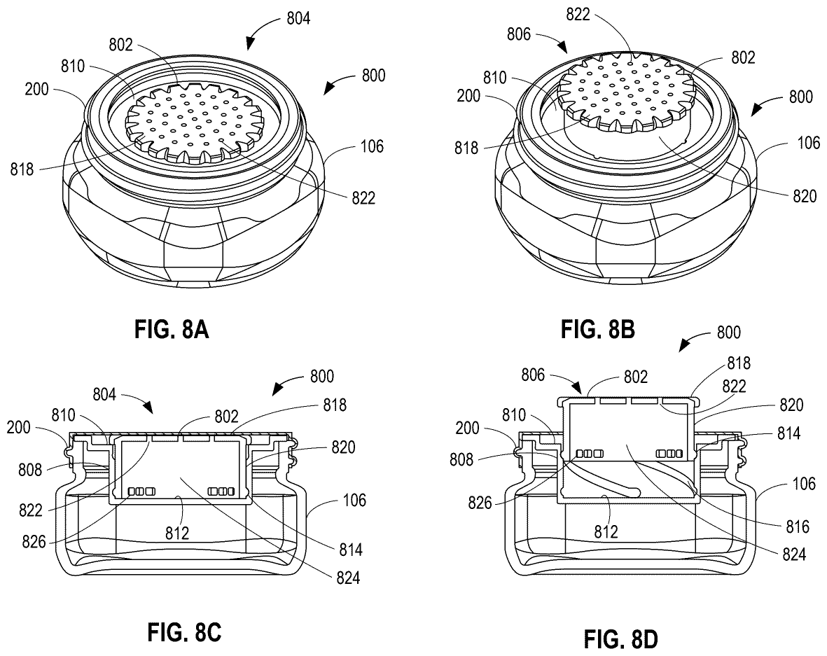

FIGS. 8A-8D show another example liquid bee feeder 800 with an example plug 802 in an example closed position 804 and an example open position 806. FIG. 8A is a perspective view of the liquid bee feeder 800 with the plug 802 in the closed position 804. FIG. 8B is a perspective view of the liquid bee feeder 800 with the plug 802 in the open position 806. FIG. 8C is a cross section of the liquid bee feeder 800 with the plug 802 in the closed position 804. FIG. 8D is a cross section of the liquid bee feeder 800 with the plug 802 in the open position 806. The plug 802 is disposed in an example recess 808 of an example lid 810. The lid 810 seals the example vessel 106 of FIG. 2. In some examples, the lid 810 is coupled to the vessel 106 by the example band 200 of FIG. 2. The plug 802 rotates between the closed position 804 and the open position 806. The rotation of plug 802 causes the plug 802 to translate away from a bottom surface 812 of the recess 808 as example protrusions 814 of the plug 802 move along example grooves 816 in the recess 808. The example plug 802 has a cylindrical shape with a top surface 818 and a sidewall 820 extending from the top surface 818 towards the bottom surface 812 of the recess 808. Example passages 822 (e.g., openings, feeding ports, etc.), that allow liquid bee feed to be accessed by bees for feeding, are located on the top surface 818 of the plug 802. For clarity, not every passage 822 is labeled in FIGS. 8A-8D, but it is understood that similar shapes in proximity to a labeled passage 822 is also a passage 822. The passages 822 fluidly couple an example feed cavity 824 to the top surface 818. The feed cavity 824 includes space between the plug 802 and the recess 808. The plug 802 includes example openings 826 in the sidewall 820. For clarity, not every opening 826 is labeled. The openings 826 align with fluid channels (not shown) in the recess 808 when the plug 802 is in the open position 806. Thus, when the plug 802 is in the open position 806, the vessel 106 is fluidly coupled to the feed cavity 824 and the passages 822. When the plug 802 is in the closed position 804, the openings 826 are not aligned with the fluid channels (not shown) and the vessel 106 is sealed.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

From the foregoing, it will be appreciated that example methods, apparatus, systems, and articles of manufacture to provide bees with liquid bee feed are disclosed herein. Further examples and combinations thereof include the following:

Example 1 includes a bee feeder apparatus, the bee feeder comprising a vessel, the vessel to contain liquid bee feed, a lid removably coupled to the vessel, the lid to seal the liquid bee feed within the vessel, the lid including a recess having a sidewall, the recess extending into the vessel when the lid is coupled to the vessel, and a fluid channel connecting a first side of the sidewall to a second side of the sidewall, the second side opposite the first side, the fluid channel to fluidly couple the vessel and the recess, and a plug movably coupled to the lid and disposed within the recess, the plug movable between a first position and a second position, the plug to impede the liquid bee feed from flowing through the fluid channel in the first position, the plug including a first surface including a feeding port, a second surface extending from the first surface towards the recess, the first surface and second surface at least partially defining a feed cavity, and an opening on the second surface, the opening to align with the fluid channel when the plug is in the second position to allow the liquid bee feed to flow through the fluid channel into the feed cavity and through the feeding port for consumption by bees.

Example 2 includes the bee feeder of example 1, wherein the feeding port is a cylindrical hole having a diameter of between 0.5 and 4 millimeters.

Example 3 includes the bee feeder of example 1, wherein the feeding port is one of a plurality of feeding ports on the first surface, spacing between adjacent ones of the plurality of feeding ports to be at least 5 millimeters.

Example 4 includes the bee feeder of example 1, wherein the sidewall further includes a groove and the plug further includes a protrusion on the second surface, the protrusion to move within the groove such that when the plug rotates between the first position and the second position the plug translates away from the recess.

Example 5 includes the bee feeder of example 4, further including an elastomeric ring surrounding the plug to impede the liquid bee feed from flowing past an outer surface of the plug.

Example 6 includes the bee feeder of example 1, wherein the plug includes a raised portion on the first surface, the raised portion to receive a user input to move the plug between the first position and the second position.

Example 7 includes the bee feeder of example 1, wherein the first surface of the plug is textured to provide a gripping surface for the bees.

Example 8 includes the bee feeder of example 1, wherein the lid and the first surface of the plug are made from a low surface energy material.

Example 9 includes the bee feeder of example 1, wherein the vessel is a glass jar and the lid is coupled to the glass jar by a ring, the ring threadably coupled to the glass jar.

Example 10 includes the bee feeder of example 9, wherein the lid has a flange to center the lid within an opening of the glass jar.

Example 11 includes the bee feeder of example 1, further including an ultraviolet light source to direct ultraviolet light towards the feeding port.

Example 12 includes the bee feeder of example 11, wherein the ultraviolet light source is coupled to the recess.

Example 13 includes the bee feeder of example 11, wherein the recess is made from a translucent material and the ultraviolet light source is coupled to the vessel.

Example 14 includes the bee feeder of example 1, wherein the plug contains ultraviolet light reflecting material.

Example 15 includes an apparatus for feeding bees comprising a lid having a first surface and a second surface opposite the first surface, the second surface to seal a vessel configured to hold a fluid, a recess in the lid, the recess having a fluid channel connecting the first surface and the second surface, and a plug disposed in the recess, the plug movable from a closed position to an open position, the plug to inhibit fluid flow through the fluid channel while the plug is in the closed position, the plug including an opening to fluidly couple the plug with the fluid channel while the plug is in the open position, a grip disposed on a surface of the plug, the grip to accept a user input to move the plug between the open and the closed position, and passages on the surface of the plug, the passages to allow bees to feed on the fluid.

Example 16 includes the apparatus of example 15, wherein the fluid channel is a plurality of fluid channels and the opening is a plurality of openings.

Example 17 includes the apparatus of example 15, wherein the passages are cylindrical in shape between 0.5 and 4 millimeters in diameter, adjacent ones of the passages are spaced apart at least 5 millimeters to allow bees to feed without wetting the bees.

Example 18 includes the apparatus of example 15, wherein the surface of the plug is textured to provide a gripping surface for bees.

Example 19 includes the apparatus of example 15, further including an elastomeric ring surrounding the plug to inhibit the fluid from flowing past an outer surface of the plug.

Example 20 includes the apparatus of example 15, wherein the recess further includes a groove and the plug further includes a protrusion, the plug to rotate between the closed position and the open position, the protrusion to move within the groove such that when the plug rotates between the closed position and the open position the plug moves away from the recess.

Example 21 includes the apparatus of example 15, further including an ultraviolet light source coupled to the recess, the ultraviolet light source to emit ultraviolet light through the passages.

Example 22 includes the apparatus of example 15, wherein the plug contains ultraviolet light reflecting material.

Example 23 includes an apparatus for feeding bees comprising a lid having a first surface and a second surface opposite the first surface, the second surface to seal a vessel configured to hold fluid, a fluid channel connecting the first surface and the second surface, and a cover movably coupled to the lid, the cover having an opening, the cover movable between a first position and a second position, the cover to inhibit fluid flow through the fluid channel while the cover is in the first position, the opening to allow the fluid to flow through the fluid channel while the cover is in the second position.

Example 24 includes the apparatus of example 23, wherein the lid further includes a recess and the cover is disposed within the recess.

Example 25 includes the apparatus of example 24, wherein the fluid channel is disposed on a sidewall of the recess, the opening is disposed on a sidewall of the cover, the opening to fluidly connect the fluid channel to a first side of the cover, the cover further having passages to allow fluid to travel through the cover for consumption by bees.

Example 26 includes the apparatus of example 25, wherein the sidewall of the recess further includes a groove and the cover includes a protrusion, the cover to rotate between the first position and the second position, the protrusion to move within the groove such that when the cover rotates between the first position and the second position, the cover moves away from the recess.

Example 27 includes the apparatus of example 23, further including an ultraviolet light source coupled to the lid to direct ultraviolet light past the lid when the cover is in the second position.

Example 28 includes the apparatus of example 23, wherein at least one of the lid or the cover contains ultraviolet reflecting material.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A bee feeder apparatus, the bee feeder comprising:
a vessel, the vessel to contain liquid bee feed;
a lid removably coupled to the vessel, the lid to seal the liquid bee feed within the vessel, the lid including:
a recess having a sidewall, the recess extending into the vessel when the lid is coupled to the vessel; and
a fluid channel connecting a first side of the sidewall to a second side of the sidewall, the second side opposite the first side, the fluid channel to fluidly couple the vessel and the recess; and
a plug movably coupled to the lid and disposed within the recess, the plug movable between a first position and a second position, the plug to impede the liquid bee feed from flowing through the fluid channel in the first position, the plug including:
a first surface including a feeding port;
a second surface extending from the first surface towards the recess, the first surface and second surface at least partially defining a feed cavity; and
an opening on the second surface, the opening to align with the fluid channel when the plug is in the second position to allow the liquid bee feed to flow through the fluid channel into the feed cavity and through the feeding port for consumption by bees.

2. The bee feeder of claim 1, wherein the feeding port is a cylindrical hole having a diameter of between 0.5 and 4 millimeters.

3. The bee feeder of claim 1, wherein the feeding port is one of a plurality of feeding ports on the first surface, spacing between adjacent ones of the plurality of feeding ports to be at least 5 millimeters.

4. The bee feeder of claim 1, wherein the sidewall further includes a groove and the plug further includes a protrusion on the second surface, the protrusion to move within the groove such that when the plug rotates between the first position and the second position the plug translates away from the recess.

5. The bee feeder of claim 4, further including an elastomeric ring surrounding the plug to impede the liquid bee feed from flowing past an outer surface of the plug.

6. The bee feeder of claim 1, wherein the plug includes a raised portion on the first surface, the raised portion to receive a user input to move the plug between the first position and the second position.

7. The bee feeder of claim 1, wherein the first surface of the plug is textured to provide a gripping surface for the bees.

8. The bee feeder of claim 1, wherein the lid and the first surface of the plug are made from a low surface energy material.

9. The bee feeder of claim 1, wherein the vessel is a glass jar and the lid is coupled to the glass jar by a ring, the ring threadably coupled to the glass jar.

10. The bee feeder of claim 9, wherein the lid has a flange to center the lid within an opening of the glass jar.

11. The bee feeder of claim 1, further including an ultraviolet light source to direct ultraviolet light towards the feeding port.

12. The bee feeder of claim 11, wherein the ultraviolet light source is coupled to the recess.

13. The bee feeder of claim 11, wherein the recess is made from a translucent material and the ultraviolet light source is coupled to the vessel.

14. The bee feeder of claim 1, wherein the plug contains ultraviolet light reflecting material.

15. An apparatus for feeding bees comprising:
a lid having a first surface and a second surface opposite the first surface, the second surface to seal a vessel configured to hold a fluid;
a recess in the lid, the recess having a fluid channel connecting the first surface and the second surface; and
a plug disposed in the recess, the plug movable from a closed position to an open position, the plug to inhibit fluid flow through the fluid channel while the plug is in the closed position, the plug including:
an opening to fluidly couple the plug with the fluid channel while the plug is in the open position;
a grip disposed on a surface of the plug, the grip to accept a user input to move the plug between the open and the closed position; and
passages on the surface of the plug, the passages to allow bees to feed on the fluid.

16. The apparatus of claim 15, wherein the fluid channel is a plurality of fluid channels and the opening is a plurality of openings.

17. The apparatus of claim 15, wherein the passages are cylindrical in shape between 0.5 and 4 millimeters in diameter, adjacent ones of the passages are spaced apart at least 5 millimeters to allow bees to feed without wetting the bees.

18. The apparatus of claim 15, wherein the surface of the plug is textured to provide a gripping surface for bees.

19. The apparatus of claim 15, further including an elastomeric ring surrounding the plug to inhibit the fluid from flowing past an outer surface of the plug.

20. The apparatus of claim 15, wherein the recess further includes a groove and the plug further includes a protrusion, the plug to rotate between the closed position and the open position, the protrusion to move within the groove such that when the plug rotates between the closed position and the open position the plug moves away from the recess.

21. The apparatus of claim 15, further including an ultraviolet light source coupled to the recess, the ultraviolet light source to emit ultraviolet light through the passages.

22. The apparatus of claim 15, wherein the plug contains ultraviolet light reflecting material.

23. An apparatus for feeding bees comprising:
a lid having a first surface and a second surface opposite the first surface, the second surface to seal a vessel configured to hold fluid;
a fluid channel connecting the first surface and the second surface; and
a cover movably coupled to the lid, the cover having an opening, the cover movable between a first position and a second position, the cover to inhibit fluid flow through the fluid channel while the cover is in the first position, the opening to allow the fluid to flow through the fluid channel while the cover is in the second position.

24. The apparatus of claim 23, wherein the lid further includes a recess and the cover is disposed within the recess.

25. The apparatus of claim 24, wherein the fluid channel is disposed on a sidewall of the recess, the opening is disposed on a sidewall of the cover, the opening to fluidly connect the fluid channel to a first side of the cover, the cover further having passages to allow fluid to travel through the cover for consumption by bees.

26. The apparatus of claim 25, wherein the sidewall of the recess further includes a groove and the cover includes a protrusion, the cover to rotate between the first position and the second position, the protrusion to move within the groove such that when the cover rotates between the first position and the second position, the cover moves away from the recess.

27. The apparatus of claim 23, further including an ultraviolet light source coupled to the lid to direct ultraviolet light past the lid when the cover is in the second position.

28. The apparatus of claim 23, wherein at least one of the lid or the cover contains ultraviolet reflecting material.
